(19) United States
(12) Patent Application Publication
(10) Pub. No.: US 2014/0261098 A1
(43) Pub. Date: Sep. 18, 2014

(54) VEHICLE PLATFORM AND METHOD

(71) Applicants: Adam Giemza, Elmhurst, IL (US); Fred Jevaney, Elhurst, IL (US); Eric Colborn, Elmhurst, IL (US); Thomas Wisniewski, Elmhurst, IL (US)

(72) Inventors: Adam Giemza, Elmhurst, IL (US); Fred Jevaney, Elhurst, IL (US); Eric Colborn, Elmhurst, IL (US); Thomas Wisniewski, Elmhurst, IL (US)

(21) Appl. No.: 13/828,674

(22) Filed: Mar. 14, 2013

(51) Int. Cl. B60P 1/00

(52) U.S. Cl. CPC B60P 1/00
USPC 108/44

(57) ABSTRACT

System and method of operating can include, or be used in conjunction with, a vehicle's storage compartment with a floor and a door for access to the storage compartment. The apparatus can include a mounting frame. Other components of the apparatus can include a pair of sliding rails and a lift assembly capable of moving between a raised position and a lowered position. In the raised position the top surface of the work surface is at approximately the same level as the floor of the storage compartment, and in the lowered position the top surface of the work surface is capable of sliding under the vehicle.

### BACKGROUND

Various types of platforms exist for loading and unloading cargo in transportation and related industries. Ramps have long been integrated at the rear of cargo containers. It is at times more convenient or even necessary to load and/or unload cargo through a side door. One of the drawbacks with previous attempts is the need to unpack components of a platform from stowage and then assemble the platform. Another shortcoming in prior container systems is the lack of a platform that is flush and level with the floor of the cargo container. There is a need in the art for a product that addresses these and/or other issues and shortcomings of the prior art.

### BRIEF SUMMARY

In one aspect, the loading platform system can include a mounting frame, a work surface, at least one rail, and a lift assembly. The at least one rail can be configured to allow the work surface to move with respect to the mounting frame between an extended position and a retracted position. The at least one rail can have two or more rails so as to be part of a pair of rails. The lift assembly can be connected to the work surface and configured to allow the work surface to move between a lowered position and a raised position.

In some embodiments, the loading platform can include at least one compression spring, gas spring, or other suitable spring-type devices. The system can have one or more guardrails, and can also have at least one stop. A stop in the system can be configured to restrain movement of the work surface from the raised position toward the lower position.

In some embodiments, the work surface can be configured to be substantially flush with and parallel to a floor surface of the vehicle when the work surface is in the raised position. The spring can bias the work surface from the lowered position toward the raised position. The work surface can be configured to be restrained to a retracted position under the vehicle.

In some embodiments, the work surface can be configured to remain substantially parallel to the floor surface at intermediate positions when moving between the lowered position and the raised position. The platform can further include support components, which can include stabilizing bars.

In another aspect, the method can include moving a platform from a storage position under a vehicle with a floor to an operational position. The platform can include a work surface, a mounting frame, a pair of rails, and a lift assembly. The rails can be configured for slidable cooperation with the mounting frame. The mounting frame can be secured under the vehicle. The method can include moving the platform from the storage position under the vehicle to a first position, where no portion of the work surface is under the vehicle. The work surface can move to the first position as a result of the rails sliding within the mounting frame that is secured under the vehicle. The method can further include moving the platform from the first position to the operational position by lifting the work surface such that the top surface of the work surface is substantially level with the floor of the vehicle.

In an exemplary embodiment, moving the platform from the first position to the operational position can be assisted by a spring that biases the work surface from the lowered position to the operational position. The work surface can maintain a parallel relationship with the floor while moving from the storage position to the first position and to the operational position. Another step can include disengaging a latching mechanism to release the platform from the operational position and/or disengaging a latching mechanism to unsecure the platform from the storage position. Another step can include erecting a guardrail. A catch can also be engaged. The catch can be configured to prevent the work surface from collapsing from a raised position. A means to extract the platform from the storage position can also be engaged.

In another aspect of the system, a platform for attachment to a vehicle that includes a storage compartment is provided. The storage compartment can have a floor and a door that provides access to the storage compartment. The system can have a mounting frame secured under the storage compartment. The platform can have a work surface, the work surface having a top surface, a pair of rails, and a lift assembly. The pair of rails can be configured for slidable cooperation with the mounting frame that is secured under the vehicle. The lift assembly can connect the work surface to the pair of rails and enable the work surface to move between a raised position and a lowered position. In the raised position the top surface of the work surface can be at substantially the same level as the floor of the storage compartment, and in the lowered position the top surface of the work surface can be capable of sliding under the vehicle. The top surface can be an anti-slip surface.

In some embodiments, the lift assembly can include an element that biases the work surface from the lowered position to the raised position. The biasing element can be a compression spring and/or a gas spring. The work surface can be capable of being moved from a storage position under the vehicle to the raised position. The work surface can be parallel to the floor in the lowered position and in the raised position. The work surface can be configured to remain substantially parallel to the floor at intermediate positions between the lowered position and the raised position. In some embodiments the system can include a latching mechanism and at least one handle. The latching mechanism can be configured to maintain the platform in a storage position and/or in the raised position. In some embodiments, the system can include a guardrail. The system can include a catch. The catch can be configured to prevent the work surface from collapsing from the raised position. In yet other embodiments, the system can include means for extracting the platform from the storage position. The vehicle in some embodiments can have a cab and a storage compartment. The storage compartment can have a front-end, near the cab, a rear-end, away from the cab, and two sides extending from the front-end to the rear-end. The mounting frame can be located under the storage compartment along one of the two sides such that in the extended position the work surface extends in a direction normal from one of the two sides, in other words, in a direction perpendicular to the side and parallel to the length of the vehicle. The mounting frame can also be mounted such that the work surface extends from the rear end of the vehicle or from the front end of the storage compartment.

Other aspects, embodiments, and features will be apparent from the following description, the drawings, and the claims.

### BRIEF DESCRIPTION OF THE DRAWINGS

FIG. 1 depicts an embodiment of the system incorporated with the storage compartment of a vehicle.

FIG. 2 depicts an embodiment of the system in a stowed position.

FIG. 3 depicts an embodiment of the system in an extended and lowered position.

FIG. 4 depicts an embodiment of the system in an intermediate position.

FIG. 5 depicts an embodiment of the system in an operational position.

FIG. 6 depicts an embodiment of the system in an intermediate position and components of the system locked by a stop.

FIG. 7 depicts an embodiment of the system in an operational position and components of the system locked by a stop.

FIG. 8 depicts an embodiment of the system in a stowed position under the storage compartment of a vehicle.

FIG. 9 depicts an embodiment of the system including integrated handles and a latch release.

### DETAILED DESCRIPTION

The various exemplary embodiments described are not intended to be limiting, but rather, instructive to one of ordinary skill in the art. An embodiment is shown in FIG. 1. A platform (100) is attached to the storage compartment (partially shown in cross-section) of a vehicle. The storage compartment has a floor (108) and a doorway (107) that provides access to the storage compartment. The platform is mounted under the storage compartment by the mounting frame (103). The platform has a work surface (101). The work surface can have a grill-type top surface such as rectangular grating, diamond-cut grating, or other similar grating. Alternatively, the work surface can have a solid top surface or a combination of solid and grill. The work surface is attached to a lift assembly (104) which allows the work surface to move between a raised, operational position, and a lowered position for stowage. In the operational position, a guardrail (106) can be erected to prevent people and/or cargo from accidentally falling from the platform.

The lift assembly can include support struts and/or springs. A preferred embodiment can include one or more compression springs (105). A gas spring can be utilized in addition to or in place of a compression spring. Another functionally equivalent biasing mechanism can be used without departing from the spirit of the invention. Similarly, a mechanical lever, jack, or screw-type device can be utilized to aid in lifting and/or lowering the work surface of the platform. The mechanical device can additionally be aided by means of an electronic motor and/or electronic controls. The mechanical device can replace some or all of the struts, and the struts can be utilized without inclusion of a biasing mechanism.

Additionally, the platform can include stabilizer bars (109). These bars can give the platform stability in the working position. The stabilizer bars can provide side to side stability. The bars can be located at the front and/or rear of the platform. A left bar and a right bar can be connected to each other and to the platform and frame assembly, for example as shown in FIG. 8 (809) and in FIG. 9 (909).

The work surface of the platform slides via a pair of rails (102) between a stowed position under the vehicle and a position extending out from under the vehicle. The pair of rails can be configured for slidable cooperation with the mounting frame that is secured under the vehicle. FIG. 2 shows an embodiment wherein the work surface has been retracted into the stowed position. FIG. 3 shows an embodiment wherein the work surface is in an extended and lowered position.

The lift assembly can connect the work surface to the pair of rails and enable the work surface to move between a raised position and a lowered position. In the raised position, the top surface of the work surface can be at substantially the same level as the floor of the storage compartment, and in the lowered position the top surface of the work surface can be capable of sliding under the vehicle. The top surface can be an anti-slip surface. FIG. 4 shows the work surface in an intermediate position. FIG. 5 shows the work surface is in an operating position. The lift assembly can be configured to maintain the work surface in an orientation substantially parallel to the floor surface of the storage compartment while moving between positions. This can be achieved, as shown in the exemplary figures, by utilizing three or more struts between the work surface and each of the pair of rails. Alternatively, the work surface can be maintained in a parallel orientation by configuration of lifting mechanisms discussed herein. The work surface can be raised into an operating position such that the work surface and the storage compartment floor are substantially flush or completely level and even.

The platform can include components for securing the work surface in various positions. For example, components can include a catch that checks or holds immovable the platform in an intermediate or a raised position. The catch can be a mechanical stop, integral to the frame, configured to allow a sliding bar to slip over the stop in a first direction, while the platform rises, and then prevent the sliding bar from slipping back over the stop in a second direct. FIG. 6 shows components of an exemplary embodiment. A swing arm can be connected to the work surface. As the work surface rises, a swing arm bar (602) can slide along a guide bar. The guide bar can include a catch (601) that allows the swing arm bar to pass as the work surface rises. Once passed by swing arm bar, the catch can prevent the work surface from collapsing. Alternative catch mechanisms can include a saw-tooth guide bar rather than a single catch, a friction catch, or other catches. FIG. 7 shows components of an exemplary embodiment. A swing arm can include a swing arm catch (701) which can engage a stop bar (702). The stop bar and the swing arm catch can be used to secure the work surface in an operating position. The terms stop and catch can be used herein interchangeably.

Some embodiments can include one or more latches, releases, and/or handles. FIG. 8 shows an exemplary embodiment wherein the platform is in a stowed position under the storage compartment of a vehicle. Apertures (801) can be included in the frame of the work surface, as shown, or elsewhere on the platform. FIG. 9 shows an embodiment wherein gripping elements (901) are included near the apertures. A release (902) can be included. The release can be utilized to release one or more latches, for example, a securing latch that secures the platform in a stowed or in an operating position. The release can be utilized to release the work surface from a stowed position and/or to release the work surface from an operation position. A securing latch can also be a simple mechanism such as a Cotter pin.

The platform can include various safety features such as guardrail (106). The guardrail can be attached to the platform by fasteners, about which the guardrail can pivot so as to be movable between stowed and operating positions as shown in FIGS. 2 and 5, respectively. The guardrail can, alternatively, be unattached from the platform and have, for example, tapered ends for inserting into receptacles in the work surface. In such embodiment, the guardrail can be removed entirely from the work surface and stowed separate from or in the platform when the platform is not in the operating position. Although not shown, additional guardrail and safety features are contemplated within the scope of embodiments. For example, an additional guardrail or chain can connect the guardrail shown to the wall of the storage container so as to make two guarded sides of the platform.

Another safety feature contemplated but not shown includes a raised frame enclosing the perimeter of the work surface and slightly higher than the top surface of the work surface. Such a raised frame can provide tactile signals for proper foot placement near the edge of the work surface. Generally, the raised frame can be low enough as to allow the top surface to be substantially flush with and parallel to the floor of the storage compartment and not inhibit a dolly or truck from passing over the frame. Alternatively, the frame can have higher, even substantially higher, sections along portions of the perimeter of the work surface where loading and unloading would not occur, for example along the side with the guardrail.

The platform can be configured to have removable steps and/or a removable ramp attached to the work surface. The steps and/or ramp can be collapsible or foldable for stowage purposes. The steps and/or ramp can be foldable so as to be stowed with the platform, or they can be stowed separately from the platform. Although not limiting, an example of the steps contemplated can be the Randall two-step system.

Embodiments can be configured for easy operation by a user. In an exemplary method, the system can be in a stowed position as shown in FIG. 8. The platform can remain in the stowed position while travelling over-the-road and/or when not in use. For loading and/or unloading cargo, the user can grasp handles or, as shown, portals (801) to slide out the work surface from the stowed position along rails. The work surface, once fully extended as in FIG. 3, can be lifted by the user. A compression spring, gas spring, and/or electromechanical device can assist the user in lifting the work surface from a lowered position, through an intermediate position (shown in FIG. 4), to a raised position (shown in FIG. 5). As the work surface moves from the lowered position to the raised position, a mechanical stop can move into an engaged position, for example, to ensure the work surface does not unintentionally fall back into the lowered position. Once the user has fully raised the work surface into an operational position, the work surface can be substantially flush with the floor of the storage compartment. Next, the user can raise and secure a guardrail that can be stored on top of the work surface. FIGS. 1 and 5 show a guardrail (106) in a raised and secured position, while FIGS. 2-4 show the guardrail in a lowered position on top of the work surface.

Once fully erected, a user can take additional steps to make the platform more useful for specific tasks. For example, the user can provide an additional guardrail to prevent falling. The user can attach a ramp, a stairway, or a ladder to the platform. In some embodiments, the user can further manipulate a stairway or a ladder that is integral to or installed on the platform.

To stow the platform for travel and/or when not in use, the user can perform the method for erecting in reverse order. For example, the user can lower the guardrail. Then, the stop and/or catch mechanism can be released. Next, the platform can be moved into a lowered position. The user can then slide the work surface into a stowed position.

Embodiments have been described herein in exemplary forms for instructing a person of ordinary skill in the art. Such embodiments and/or forms are not intended to limit the following claims to specific structures or steps. Other embodiments can be practiced and/or implemented without departing from the scope and spirit of the invention. Other embodiments are within the scope of the following claims.

What is claimed is:

1. A platform for attachment to a vehicle that includes a storage compartment, wherein the storage compartment has a floor and there is a door that provides access to the storage compartment, and there is a mounting frame secured under the storage compartment, the platform comprising:
a work surface, the work surface having a top surface,
a pair of rails, the pair of rails being configured for slidable cooperation with the mounting frame that is secured under the vehicle; and
a lift assembly,
the lift assembly connecting the work surface to the pair of rails, and enabling the work surface to move between a raised position and a lowered position, wherein in the raised position the top surface of the work surface is at substantially the same level as the floor of the storage compartment, and in the lowered position the top surface of the work surface is capable of sliding under the vehicle.

2. The platform of claim 1, wherein the lift assembly includes a spring that biases the work surface from the lowered position to the raised position.

3. The platform of claim 1, wherein the work surface is capable of being moved from a storage position under the vehicle to the raised position.

4. The platform of claim 1, wherein the work surface remains substantially parallel to the floor at intermediate positions between the lowered position and the raised position.

5. The platform of claim 1, further comprising a latching mechanism and at least one handle, wherein the latching mechanism maintains the platform in a storage position or in the raised position.

6. The platform of claim 1, further comprising a guardrail.

7. The platform of claim 1, further comprising a catch, wherein the catch is configured to prevent the work surface from collapsing from the raised position.

8. A method of moving a platform from a storage position under a vehicle with a floor to an operational position, wherein the platform includes a work surface, a pair of rails, the rails being configured for slidable cooperation with a mounting frame that is secured under the vehicle, and a lift assembly, the method comprising:
moving the platform from the storage position under the vehicle to a first position where no portion of the work surface is under the vehicle, wherein the work surface moves to the first position as a result of the rails sliding within the mounting frame that is secured under the vehicle,
moving the platform from the first position to the operational position by lifting the work surface such that the top surface of the work surface is substantially level with the floor of the vehicle.

9. The method of claim 8, wherein moving the platform from the first position to the operational position is assisted by a spring that biases the work surface from the lowered position to the operational position.

10. The method of claim 8, wherein the work surface maintains a parallel relationship with the floor while moving from the storage position to the first position and to the operational position.

11. The method of claim 8, further comprising disengaging a latching mechanism to release the platform from the operational position.

12. The method of claim 8, further comprising disengaging a latching mechanism to unsecure the platform from the storage position.

13. The method of claim 8, further comprising erecting a guardrail.

14. The method of claim 8, further comprising engaging a catch, wherein the catch is configured to prevent the work surface from collapsing from a raised position.

15. A loading platform, comprising:
a mounting frame;
a work surface;
at least one rail, wherein the at least one rail is configured to allow the work surface to move with respect to the mounting frame between an extended position and a retracted position; and
a lift assembly, wherein the lift assembly is connected to the work surface and configured to allow the work surface to move between a lowered position and a raised position.

16. The platform of claim 15, further comprising at least one spring.

17. The platform of claim 16, further comprising at least one guardrail and at least one stop.

18. The platform of claim 17, wherein the at least one stop is configured to restrain movement of the work surface from the raised position toward the lower position.

19. The platform of claim 18, wherein the work surface is configured to be substantially flush with and parallel to a floor surface of a vehicle when the work surface is in the raised position;
wherein the at least one spring biases the work surface from the lowered position toward the raised position;
wherein the work surface is configured to be restrained to the retracted position under the vehicle; and
wherein the work surface remains substantially parallel to the floor surface at intermediate positions between the lowered position and the raised position.

20. The platform of claim 15, wherein the platform is attached to a vehicle and configured such that the work surface is substantially parallel to a floor surface of the vehicle, and wherein the work surface is substantially flush with the floor surface when in the raised position.
